(19) United States
(12) Patent Application Publication
(10) Pub. No.: US 2014/0285298 A1
(43) Pub. Date: Sep. 25, 2014

(54) TUNABLE INDUCTOR

(71) Applicant: MCV TECHNOLOGIES, INC., San Diego, CA (US)

(72) Inventors: Edward C. Liang, San Diego, CA (US); Georgiy Kolomichenko, Fort Myers, FL (US)

(73) Assignee: MCV Technologies, Inc., San Diego, CA (US)

(21) Appl. No.: 13/848,692

(22) Filed: Mar. 21, 2013

(51) Int. Cl. H01F 29/00

(52) U.S. Cl. CPC H01F 29/00
USPC 336/105

(57) ABSTRACT

A tunable inductor includes a first wire coil having a first terminal lead, and a second wire coil having a second terminal lead that is arranged and oriented in the same direction as the first terminal lead. The tunable inductor further includes a connecting bridge connecting the first wire coil with the second wire coil opposite the first and second terminal leads, such that the first wire coil and second wire coil are arranged in series and spaced side-by-side separated by a space. The tunable inductor further includes a mechanical tuning mechanism coupled with the connecting bridge, to provide a force down onto or a force pulling up the connecting bridge, and to respectively decrease the space between the first wire coil and the second wire coil to increase inductance, or increase the space between the first wire coil and the second wire coil to decrease inductance.

### BACKGROUND

This document describes a tunable inductor, and more particularly to production of electrical components for electrical circuits, specifically for precision Radio Frequency (RF) applications.

An inductor is a device intended for storing magnetic energy. The amount of stored energy is defined with an inductance of the inductor, and which is measured in the unit of Henry. Inductors are available in a wide variety of sizes and levels of precision.

Tunable inductors are sometimes referred as variable inductors. For some tunable inductors, the inductance can be adjusted by turning an adjustment screw with a small screwdriver. It typically takes several turns of the adjustment screw to reach the desired end value, allowing for some degree of accuracy. Conventional tunable inductors consist of wire wound around a core and a screw made of magnetic material such as ferrite. When the adjustment screw is turned it goes deeper into the core where the magnetic field has maximum concentration, and results in changing the inductance value.

In some instances, prior art tunable inductors use two coaxial coils connected together by wires or leads, which also lead out to the environment external to the inductor. A tuning screw is rotated, which squeezes or expands the coils, changing the inductance value. At higher frequency (RF), the bent shape of the leads contributes an unknown and uncontrollable inductance. Further, the shape of the bent wire may not be the same after multiple tuning. Additionally, the leads degrade the Q-value of the inductor, inserting some resistive losses into the inductor coil. Accordingly, using such leads may create problems, especially when the inductor is subjected to mechanical vibration.

Other prior art tunable inductors use two printed coils, i.e. metallic coils that are printed directly on a printed circuit board. One of the coils is electrically shortened, and when it moves along rails, the coupling between the coils changes, thus changes the effective inductance value of the other coil. While this tuning mechanism is suitable for high frequency applications, the Q-value of the inductor is diminished.

However, conventional tunable inductors have low accuracy and limited range of inductance value. These conventional tunable inductors further do not allow automatic digital control of the inductance value with high accuracy, as is required for applications such as tunable RF filters.

### SUMMARY

This document presents a tunable inductor that overcomes the limitations of conventional inductors. A tunable inductor, as described herein, is suitable for the production of electrical components for electrical circuits, specifically for precision Radio Frequency (RF) applications. In preferred exemplary implementations, a tunable inductor is mechanically tunable, i.e., an inductor having an inductance that can be adjusted, or tuned, by means of an external mechanical control. The external control is preferably a mechanical driver powered by a stepper motor, the motion of which is controlled digitally from a computer or computer-implemented controller. The scope of this disclosure excludes electrically tunable inductors, such as PIN-diode switched inductors.

In one aspect, a tunable inductor includes a first wire coil having a first terminal lead, and a second wire coil having a second terminal lead that is arranged and oriented in the same direction as the first terminal lead. The tunable inductor further includes a connecting bridge connecting the first wire coil with the second wire coil opposite the first and second terminal leads, such that the first wire coil and second wire coil are arranged in series and spaced side-by-side separated by a space. The tunable inductor further includes a mechanical tuning mechanism coupled with the connecting bridge. The mechanical tuning mechanism provides a force down onto or a force pulling up the connecting bridge, to respectively decrease the space between the first wire coil and the second wire coil to increase inductance, or increase the space between the first wire coil and the second wire coil to decrease inductance.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a tunable inductor in accordance with implementations of the present disclosure.

Like reference symbols in the various drawings indicate like elements.

### DETAILED DESCRIPTION

This document describes a tunable inductor. The tunable inductor is mechanically tunable, such that its inductance can be adjusted, or tuned, by means of an external mechanical control. The external control is preferably a mechanical driver powered by a stepper motor, the motion of which is controlled digitally from a computer or computer-implemented controller. Other mechanical tuning mechanisms can also be used.

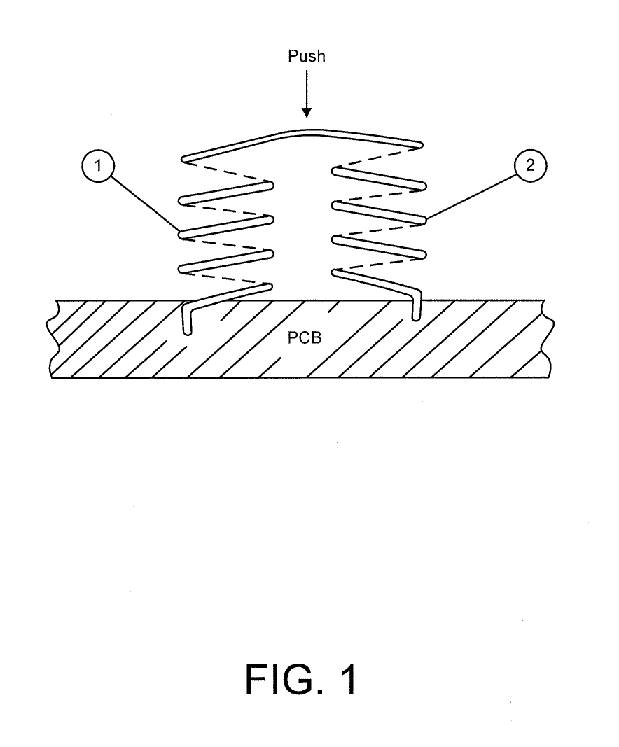

FIG. 1 illustrates a tunable inductor 100 in accordance with a preferred implementation. The tunable inductor 100 includes a first wound wire coil 1 and a second wound wire coil 2. The first wound wire coil 1 and second wound wire coil 2 are each an inductor coil, and are connected electrically in series and physically in a manner such that they create a magnetic flux loop similar to in a toroidal inductor, i.e. the magnetic field of the two coils 1 and 2 are summed. Accordingly, the magnetic field strength lines are circular inside the coils from one coil to the other. The total inductance value of the two coils is therefore two to four times the inductance of only one coil.

The magnetic field and consequently, the total inductance, depend on the toroidal size, or in other words the spacing between the coils' turns. When a force 3 from a stepper motor or the like pushes on the coils 1, 2, on the top where they are connected and opposite their respective connection to a printed circuit board (PCB) or other substrate, the spacing between coils 1 and 2 decreases, thereby increasing inductance. When the force 3 pulls the top of the coils 1, 2 away from the PCB or opposite terminal end points of the coils 1, 2, the spacing between the coils increases, and inductance decreases.

In other words, the coils create a closed magnetic way going circularly through the two coils or springs. It results in increase the total inductor value two to four times, depending on mutual coupling coefficient:

$$L = \frac{1.7 \cdot {N}^{1.3} \cdot {( D + d )}^{1.7}}{{( S + d )}^{0.7}} , \qquad ( 1 )$$

where
L-inductance of the coil, (nH),
N-number of wire turns,
D-inside diameter, (in),
d-wire diameter, (in),
S-spacing between the turns, (in).

As described above, the coils can be squeezed or expanded by an external force, exerted on the top of the two coils from a stepper-motor. The spacing S between the wire turns change, and this results in changing the inductance value L, as it is seen from the formula (1). When the coils are squeezed, the inductance is maximal. When the coils are expanded the inductance is minimal. The stepper motor motion is controlled digitally from a computer or computer-implemented controller.

This tunable inductor described herein provides for higher accuracy of the inductance value in the designed range than conventional tunable inductors, via the two wire wound coils, connected in series, which can change inductance value by being squeezed or expanded by a force exerted by the stepper-motor. Accordingly, the variable inductor does not need any tuning screw. And a stepper motor can be digitally controlled to control the inductance value. Further, the terminal leads of each coil of the variable inductor are straight and directed into the same direction, allowing easy mounting on a PCB or the like. The straight leads avoid the use of bent wires such as in some prior art inductors, and therefore the tunable inductor as described herein has advantages of having a predictable and consistent inductor value even after multiple tuning and it is higher quality factor Q for high frequency applications.

The tunable inductor described herein has high accuracy of its inductance value, and solves the problem in tunable filters which utilize tunable inductors as one of their tunable elements. Other advantages include a wide range of tunable value, high level of RF power, high quality factor of the capacitor Q, close magnetic way, and small leakage loss.

Although a few embodiments have been described in detail above, other modifications are possible. Other embodiments may be within the scope of the following claims.

1. A tunable inductor comprising:
a first wire coil having a first terminal lead;
a second wire coil having a second terminal lead that is arranged and oriented in the same direction as the first terminal lead;
a connecting bridge connecting the first wire coil with the second wire coil opposite the first and second terminal leads, such that the first wire coil and second wire coil are arranged in series and spaced side-by-side separated by a space; and
a mechanical tuning mechanism coupled with the connecting bridge, the mechanical tuning mechanism providing a force down onto or to pull up the connecting bridge, to respectively decrease the space between the first wire coil and the second wire coil to increase inductance, or increase the space between the first wire coil and the second wire coil to decrease inductance.

2. The tunable inductor in accordance with claim 1, wherein the mechanical tuning mechanism includes a stepper motor.

3. The tunable inductor in accordance with claim 2, further comprising a computer to control the stepper motor.

4. The tunable inductor in accordance with claim 1, further comprising an current source to provide an electric current to the first wire coil and the second wire coil,

5. The tunable inductor in accordance with claim 4, wherein the electric current generates a magnetic flux in each of the first wire coil and the second wire coil.

6. A tunable inductor system comprising:
a printed circuit board;
a first wire coil having a first terminal lead connected to the printed circuit board;
a second wire coil having a second terminal lead connected to the printed circuit board, the second terminal lead being arranged and oriented in the same direction as the first terminal lead;
a connecting bridge connecting the first wire coil with the second wire coil opposite the printed circuit board, such that the first wire coil and second wire coil are arranged in series and spaced side-by-side separated by a space; and
a mechanical tuning mechanism coupled with the connecting bridge, the mechanical tuning mechanism providing a force down onto or to pull up the connecting bridge, to respectively decrease the space between the first wire coil and the second wire coil to increase inductance, or increase the space between the first wire coil and the second wire coil to decrease inductance.

7. The tunable inductor system in accordance with claim 6, wherein the mechanical tuning mechanism includes a stepper motor.

8. The tunable inductor system in accordance with claim 7, further comprising a computer to control the stepper motor.

9. The tunable inductor system in accordance with claim 6, further comprising an current source to provide an electric current to the first wire coil and the second wire coil,

10. The tunable inductor system in accordance with claim 9, wherein the electric current generates a magnetic flux in each of the first wire coil and the second wire coil.
